(19) United States
(12) Patent Application Publication
(10) Pub. No.: US 2008/0101624 A1
(43) Pub. Date: May 1, 2008

(54) SPEAKER DIRECTIONALITY FOR USER INTERFACE ENHANCEMENT

(75) Inventors: PHILIP A. SCHENTRUP, HOLLYWOOD, FL (US); VON A. MOCK, BOYNTON BEACH, FL (US); CHARLES P. SCHULTZ, NORTH MIAMI BEACH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/552,493

(22) Filed: Oct. 24, 2006

(51) Int. Cl. H04R 3/00; H04R 1/02

(52) U.S. Cl. 381/92; 381/91

(57) ABSTRACT

A method (10) and system (200) for user interface enhancement using speaker directionality can include a speaker phone having a microphone array (35, 36, and 37) on a communication device (32) at a first location and a processor (202) coupled to the microphone array. The processor can be programmed to associate (12) a speaker direction with a given speaker using the microphone array and identify (14) the given speaker and provide an indication of the given speaker at a communication device (42) at a second location in communication with the communication device at the first location. The processor can be further programmed to map (18) or assign sectors to a number of speakers using the microphone array in the first location based on speaker directionality of each of the number of speakers.

### FIELD

This invention relates generally to communication systems, and more particularly to a speaker phone system and method utilizing speaker directionality.

### BACKGROUND

The classic phone has an omni-directional microphone. When a speaker phone is used in a conference call or when hands-free phone operation is used on a phone, there is no way for the radio to use directionality of sound in order to enhance a user experience. Two specific scenarios illustrate the problems encountered with existing speaker phones. In a first scenario, a conference call can occur where several people participate in the call from a common location. It is often difficult for people not physically present in the room with a talker to determine who is speaking. In a second scenario, where a radio or speaker phone includes the ability to use voice activity detection to determine when to unlock the radio's microphone and begin an audio transmission another problem is encountered. In this special mode, sometimes referred to as a VOX mode, the radio determines the user's intent to provide inbound audio by detecting audio during a certain timing window. One drawback with such voice activity detection systems is that they are not selective about whose voice is used to unlock the microphone while in the VOX timing window. This leads to a problem where other close-by talkers can trigger the radio to open the microphone and begin transmitting, even though the primary user does not intend for this to happen. Today, this problem is usually countered by adjusting microphone gain levels so that only audio of a given intensity can un-mute the microphone and start an inbound audio transmission. No existing system is known that uses speaker directionality or speaker identification technology to enhance the user experience or user interface used with speaker phones.

Some enabling technologies are known that can provide algorithms to assist in determining the position of a talker relative to a microphone array or for computing a location of an acoustic source. Some similar technology has been used in video conferencing to enable the adjustment of a camera to capture a speaker or in other words to point a camera at the speaker in a video conferencing implementation. There are also handset-dependent normalizing models for speaker recognition. Yet, even with all these enabling technologies available, no existing system is known that uses speaker directionality or speaker identification technology to enhance the user experience or user interface used with speaker phones.

### SUMMARY

Embodiments in accordance with the present invention can provide methods and systems that use speaker directionality or speaker identity to enhance user interfaces or the overall user experience in conjunction with speaker phones.

In a first embodiment of the present invention, a method of enhancing user interfaces using speaker directionality can include the steps of associating a speaker direction with a given speaker using a microphone array on a communication device at a first location and identifying the given speaker and providing an indication of the given speaker at a communication device at a second location in communication with the communication device at the first location. The method can further include the step of mapping or assigning sectors to a number of speakers using the microphone array in the first location based on speaker directionality of each of the number of speakers. The method can also provide the indication of the given speaker or speakers by embedding information within a communication channel between the communication device at the first location and at least the communication device at the second location or other locations and enabling the presentation of the indication of the given speakers or speakers at all remote locations. The method can also enable a user to add a given speaker name or identifier based on a previously stored voice profile. Thus, the indication of the given speaker(s) can be a symbol or an image or text or other format representative of the speaker or it can be the speaker's name. No limitation is intended as to the format of the indication of the speaker. The method can also enable a user to manually add a given speaker name or identifier to the given speaker as the given speaker is speaking or to manually map or assign predetermined locations at the first location with given speaker names or identifiers. The method can also lock out or mute other audio from a direction other than audio from a direction coming from the given speaker or audio identified as being from the given speaker.

In a second embodiment of the present invention, a system of enhancing user interfaces using speaker directionality can include a speaker phone having a microphone array on a communication device at a first location and a processor coupled to the microphone array. The processor can be programmed to associate a speaker direction with a given speaker using the microphone array and identify the given speaker and provide an indication of the given speaker at a communication device at a second location in communication with the communication device at the first location. The processor can also be programmed to map or assign sectors to a number of speakers using the microphone array in the first location based on speaker directionality of each of the number of speakers. The processor can also be programmed to provide the indication of the given speaker or an indication of a number of speakers by embedding information within a communication channel between the communication device at the first location and at least the communication device at the second location or other locations and enables the presentation of the indication of the given speaker or speakers at all remote locations. The processor can also enable a user to add a given speaker name or identifier based on a previously stored voice profile. The processor can also enable a user to manually add a given speaker name or identifier to the given speaker as the given speaker is speaking or to enable a user to manually map or assign predetermined locations at the first location with given speaker names or identifiers. As noted above, the system can lock out or mute other audio from a direction other than audio from a direction coming from the given speaker or audio identified as being from the given speaker. Note, the speaker phone can be a portion of a portable cellular phone, a personal digital assistant, a laptop computer, a desktop computer, a smart phone, a handheld game device or a portable entertainment device.

In a third embodiment of the present invention, a wireless communication unit having a system of enhancing user interfaces using speaker directionality can include a transceiver, a speaker phone having a microphone array on a communication device at a first location, and a processor coupled to the microphone array and transceiver. The processor can be programmed to associate a speaker direction with a given speaker using the microphone array and identify the given speaker and provide an indication of the given speaker at a communication device at a second location in communication with the communication device at the first location. The processor can also be programmed to map or assign sectors to a number of speakers using the microphone array in the first location based on speaker directionality of each of the number of speakers. The processor can also provide the indication of the given speaker by embedding information within a communication channel between the communication device at the first location and the communication device at the second location. The processor further enables a user to add a given speaker name or identifier based on a previously stored voice profile, or manually add a given speaker name or identifier to the given speaker as the given speaker is speaking, or to manually map or assign predetermined locations at the first location with given speaker names or identifiers. The processor can also be programmed to lock out or mute other audio from a direction other than audio from a direction coming from the given speaker or audio identified as being from the given speaker.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements. A microphone array should generally be understood to be a plurality of microphones at different locations. This could include different locations on a single device. Using sound propagation principles, the individual microphone signals can be filtered and combined to enhance sound originating from a particular direction or location and the location of the principal sound sources can also be determined dynamically by investigating the correlation between different microphone channels. A speaker phone can be a telephone, cellular phone or other communication device with a microphone and loudspeaker provided separately from those in the handset. In this way, more than one person can participate in a conversation using this device. The loudspeaker broadcasts the voice or voices of those on the other end of the communication line, while the microphone captures all voices of those using the speakerphone.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart of a method of enhancing user interfaces using speaker directionality in accordance with an embodiment of the present invention.

FIG. 2 is an illustration of a system for enhancing user interfaces using speaker directionality in accordance with an embodiment of the present invention.

FIG. 3 is another illustration of the system of FIG. 2 in accordance with an embodiment of the present invention.

FIG. 4 is a illustration of a schematic diagram of a system for enhancing user interfaced in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways that can enhance a communication experience for a cell phone user or a speaker phone user, particularly in conference calls with a number of people.

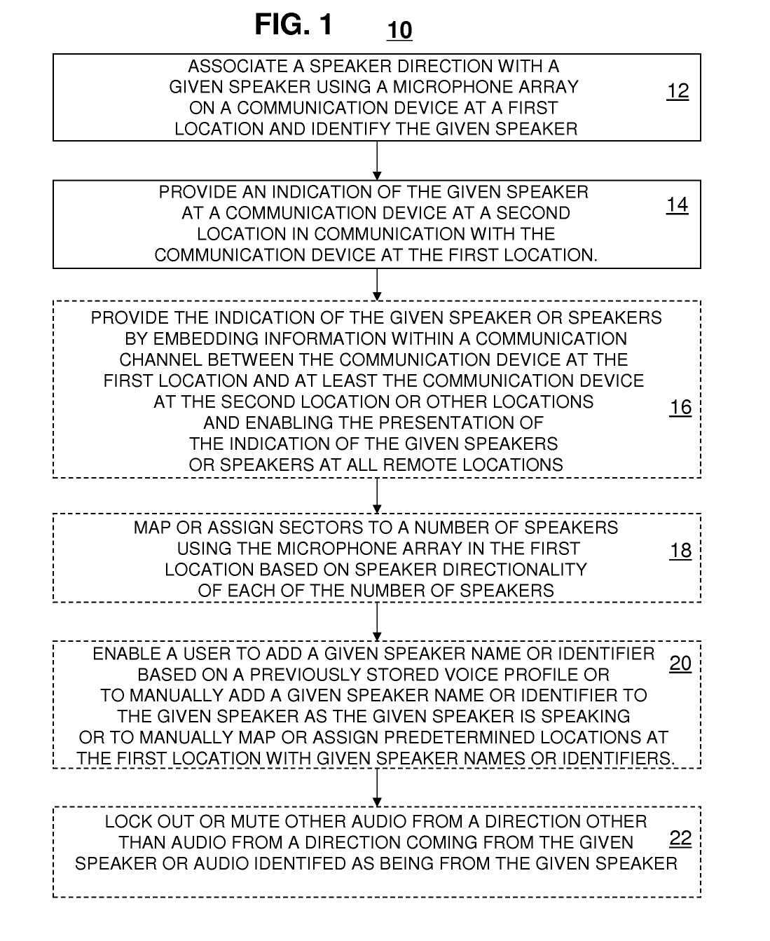

Referring to the flow chart of FIG. 1, a method 10 of enhancing user interfaces using speaker directionality includes the step 12 of associating a speaker direction with a given speaker using a microphone array on a communication device at a first location and identifying the given speaker and providing at step 14 an indication of the given speaker at a communication device at a second location in communication with the communication device at the first location. The method 10 can also provide at step 16 the indication of the given speaker or speakers by embedding information within a communication channel between the communication device at the first location and at least the communication device at the second location or other locations and enabling the presentation of the indication of the given speakers or speakers at all remote locations. The method 10 can further optionally include the step 18 of mapping or assigning sectors to a number of speakers using the microphone array in the first location based on speaker directionality of each of the number of speakers. The method 10 can also enable a user to add a given speaker name or identifier based on a previously stored voice profile or to manually add a given speaker name or identifier to the given speaker as the given speaker is speaking or to manually map or assign predetermined locations at the first location with given speaker names or identifiers at step 20. The method 10 can also lock out or mute other audio from a direction other than audio from a direction coming from the given speaker or audio identified as being from the given speaker at step 22.

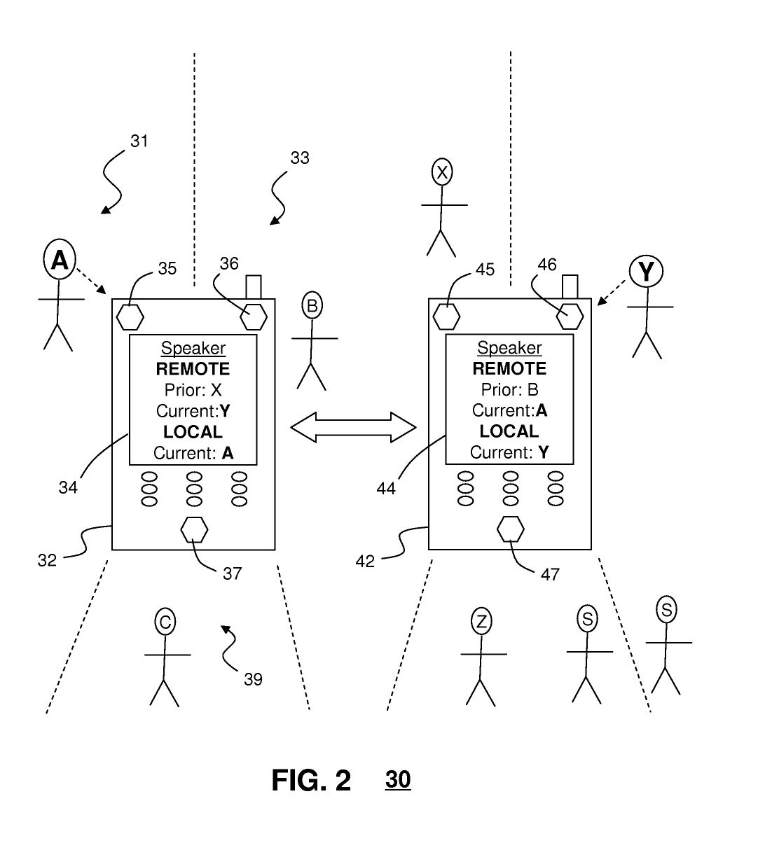

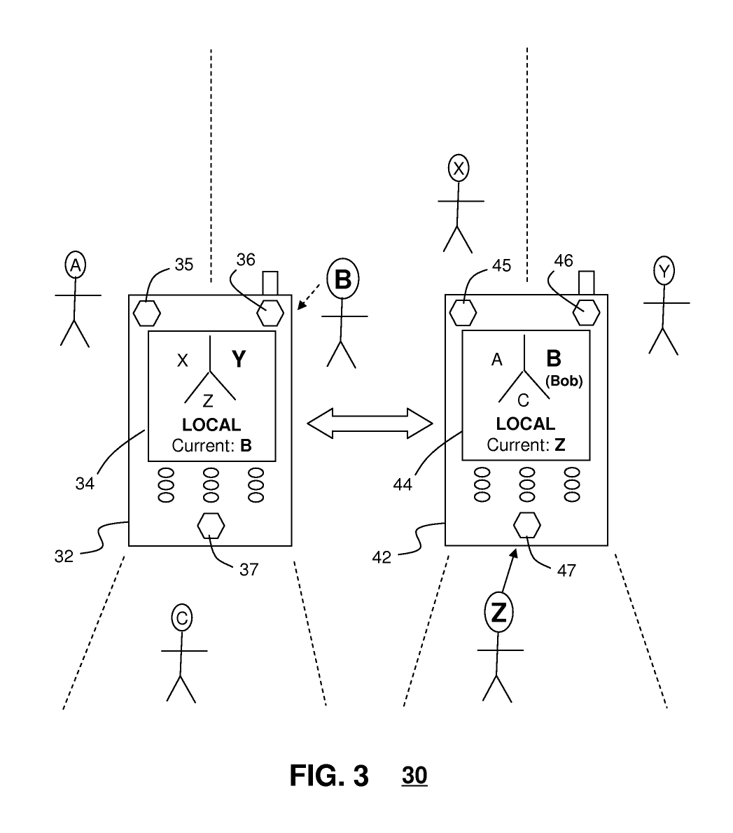

With the use of microphone arrays and beam forming technologies, speaker phones can determine the directionality of sound. A phone 32 in a communication system 30 equipped with a microphone array having microphones 35, 36, and 37 (for example) as illustrated in FIG. 2 can be used to determine the directionality of a speaker. The phone 32 further includes a user interface or display 34 that can provide an indication of a current speaker (Y) at a remote location such as the phone 42. The display can also provide an indication of the current speaker (A) in the local area. This ability can be optionally or alternatively coupled with a “map” that indicates the location of all participants in the room, or can provide the capability for the phone to identify the speaker in more concrete or specific terms using names or other identifiers. The map can be provided in many ways, but one way can allow the user to input a speaker's name while the person is speaking. The phone can then associate audio from the speaker's direction with the name. Another way of providing an indication of speakers can use available map templates for a given conference room enabling a user to assign locations and names and subsequently upload the information to the phone. In FIG. 2, the speaker A is associated with a zone 31, the speaker B is associated with a zone 33, and the speaker C is associated with a zone 39. Likewise, in a remote phone that also optionally includes similar technology, the speakers X, Y, and Z can be associated with respective zones based on the configuration of the phone and microphone array. The connection to the phone can be through a standard wired link or wireless link. The phone 32 co-located with the speaker A can communicate such identity information to the far speakers (X, Y, and Z) on the remote phone 42 via embedded or overhead information (ACP, ieXchange, etc). The far end phone 42 can then display the current speaker (A) at the local phone as shown in FIG. 2 or can alternatively show a map with the persons name or an indicator of the speaker's name as shown in FIG. 3. In this way multiple locations could link together with speakers identified to all other locations. Although two locations are shown in the embodiments, three or more locations can also implement or adapt the inventive concepts herein within contemplation of the recited claims. As another example, assume there are two locations as shown in FIGS. 2 and 3 where one location has phone 32 and the other location as phone 42. Each location has 3 participants, A, B, and C and X, Y, Z respectively. Assuming that mapping of speaker to location has been completed, when person A speaks, X, Y, and Z at phone 42 can see a display indicating person A is speaking. The display could be on the phone, on a computer linked to the phone, or a projector linked to the phone. The display 44 at phone 42 can optionally display a prior speaker (“B”) at phone 32 as well as a current speaker (“Y”) locally at a phone 42. The speaker location can also be used to lock out speakers in order to provide the ability for support staff to be involved in a call without them interfering with the call. For example, speakers “S” in either the speaker's zone or outside the speaker zone as shown in FIG. 2 can be locked out. Identifying speaker Y and mapping speaker Y to a specific zone in such instance will easily enable such lock out regardless what of zone speaker S may be residing.

Embodiments herein can also enable the ability to automatically prompt a user to add an individual's name or a representation of such individual into the conversation based on previous voice print information or a voice profile that can be stored for such individual. By using this technology, people can be added to the voice map automatically and can simplify the setup process for known associates or individual frequently using such a system.

As noted above, embodiments herein can be used to detect directionality of sound to determine the direction of the user and to lock out voices from other directions. Referring once again to FIG. 2, Person A is the intended user on phone 32. People B and C are other people in proximity to “A” who might be carrying on a conversation among themselves. The communication device being used by A segments the area around the device into different sectors or areas 31, 33, and 39 as discussed above and can lock out audio that does not come from the sector or sectors containing Person A. The number of sectors and the relative size of sectors are design constraints that can be determined based on user group needs. The sectors can also be user controllable. The current sectoring can be displayed on a display (as shown in FIG. 3) so that a user would know what areas of audio are being blocked.

Other enhancements can involve the ability to increase the gain for the voice of participants which are farthest away from the microphone(s) (so that all participants are heard equally at the other end) or the inclusion of microphone(s) on the back of the handset as part of the microphone array so that the phone can be stood vertically on the table to better capture sound from all parts of a room. Note that all conference room telephones are currently designed to lay flat on the table and thus offering very little depth/distance information to the sound. A vertical standing microphone array can greatly enhance directionality clues. The indication of speaker directionality sent to the remote party can also include an approximate indication of how far (perceived or approximated) each speaker is in relation to the handset.

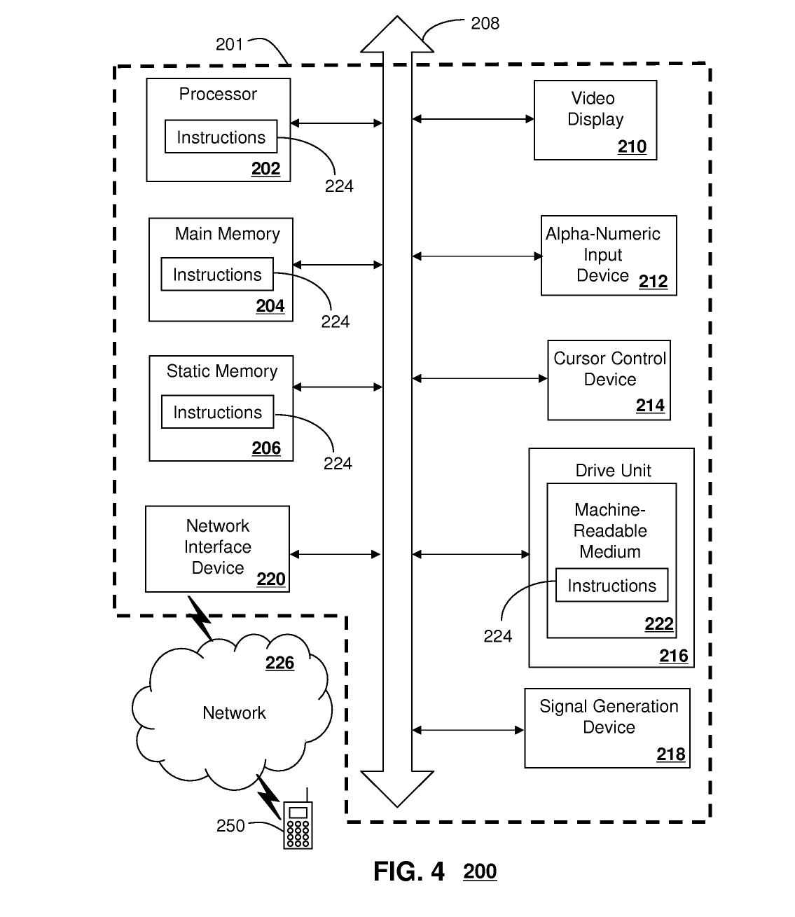

FIG. 4 depicts an exemplary diagrammatic representation of a machine in the form of a computer system 200 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such as a video display unit 210 (e.g., a liquid crystal display (LCD), a flat panel, a solid state display, or a cathode ray tube (CRT)). The computer system 200 may include an input device 212 (e.g., a keyboard), a cursor control device 214 (e.g., a mouse), a disk drive unit 216, a signal generation device 218 (e.g., a speaker or remote control that can also serve as a presentation device) and a network interface device 220. Of course, in the embodiments disclosed, many of these items are optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, and/or within the processor 202 during execution thereof by the computer system 200. The main memory 204 and the processor 202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing or virtual machine processing and can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a midlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of enhancing user interfaces using speaker directionality, comprising the steps of:
associating a speaker direction with a given speaker using a microphone array on a communication device at a first location; and
identifying the given speaker and providing an indication of the given speaker at a communication device at a second location in communication with the communication device at the first location.

2. The method of claim 1, wherein the method further comprises the step of mapping or assigning sectors to a number of speakers using the microphone array in the first location based on speaker directionality of each of the number of speakers.

3. The method of claim 1, wherein the method further comprises the step of providing the indication of the given speaker or speakers by embedding information within a communication channel between the communication device at the first location and at least the communication device at the second location or other locations and enabling the presentation of the indication of the given speakers or speakers at all remote locations.

4. The method of claim 1, wherein the method further comprises the step of enabling a user to add a given speaker name or identifier based on a previously stored voice profile.

5. The method of claim 1, wherein the method further comprises the step of enabling a user to manually add a given speaker name or identifier to the given speaker as the given speaker is speaking.

6. The method of claim 1, wherein the method further comprises the step of enabling a user to manually map or assign predetermined locations at the first location with given speaker names or identifiers.

7. The method of claim 1, wherein the method further comprises the step of locking out or muting other audio from a direction other than audio from a direction coming from the given speaker or audio identified as being from the given speaker.

8. A system of enhancing user interfaces using speaker directionality, comprising:
a speaker phone having a microphone array on a communication device at a first location;
a processor coupled to the microphone array, wherein the processor is programmed to:
associate a speaker direction with a given speaker using the microphone array; and
identify the given speaker and provide an indication of the given speaker at a communication device at a second location in communication with the communication device at the first location.

9. The system of claim 8, wherein the processor is further programmed to map or assign sectors to a number of speakers using the microphone array in the first location based on speaker directionality of each of the number of speakers.

10. The system of claim 8, wherein the processor provides the indication of the given speaker or an indication of a number of speakers by embedding information within a communication channel between the communication device at the first location and at least the communication device at the second location or other locations and enables the presentation of the indication of the given speaker or speakers at all remote locations.

11. The system of claim 8, wherein the processor further enables a user to add a given speaker name or identifier based on a previously stored voice profile.

12. The system of claim 8, wherein the processor further enables a user to manually add a given speaker name or identifier to the given speaker as the given speaker is speaking.

13. The system of claim 8, wherein the processor is further programmed to enable a user to manually map or assign predetermined locations at the first location with given speaker names or identifiers.

14. The system of claim 8, wherein the processor is further programmed to lock out or mute other audio from a direction other than audio from a direction coming from the given speaker or audio identified as being from the given speaker.

15. The system of claim 8, wherein the speaker phone is a portion of a portable cellular phone, a personal digital assistant, a laptop computer, a desktop computer, a smart phone, a handheld game device or a portable entertainment device.

16. A wireless communication unit having a system of enhancing user interfaces using speaker directionality, comprising:
a transceiver;
a speaker phone having a microphone array on a communication device at a first location;
a processor coupled to the microphone array and transceiver, wherein the processor is programmed to:
associate a speaker direction with a given speaker using the microphone array; and
identify the given speaker and provide an indication of the given speaker at a communication device at a second location in communication with the communication device at the first location.

17. The wireless communication unit of claim 16, wherein the processor is further programmed to map or assign sectors to a number of speakers using the microphone array in the first location based on speaker directionality of each of the number of speakers.

18. The wireless communication unit of claim 16, wherein the processor provides the indication of the given speaker by embedding information within a communication channel between the communication device at the first location and the communication device at the second location.

19. The wireless communication unit of claim 18, wherein the processor further enables a user to add a given speaker name or identifier based on a previously stored voice profile, or manually add a given speaker name or identifier to the given speaker as the given speaker is speaking, or to manually map or assign predetermined locations at the first location with given speaker names or identifiers.

20. The wireless communication unit of claim 16, wherein the processor is further programmed to lock out or mute other audio from a direction other than audio from a direction coming from the given speaker or audio identified as being from the given speaker.
